(19) United States
(12) Patent Application Publication
(10) Pub. No.: US 2018/0179967 A1
(43) Pub. Date: Jun. 28, 2018

(54) COMBUSTION SYSTEM AND METHOD

(71) Applicants: AVOCET SOLUTIONS INC., Hockessin, DE (US); AVOCET INFINITE PLC, Berwick upon Tweed (GB)

(72) Inventors: James Robert JENNINGS, Yarm (GB); Glyn David SHORT, Hockessin, DE (US)

(21) Appl. No.: 15/323,239

(22) PCT Filed: Jul. 3, 2015
(86) PCT No.: PCT/EP2015/025043

§ 371 Date: Dec. 30, 2016

(30) Foreign Application Priority Data
Jul. 3, 2014 (GB) 1411859.0
Jul. 3, 2014 (GB) 1411862.4

(51) Int. Cl. F02D 41/00; F02D 19/06; F02D 19/12; F02M 37/00; C10L 1/23; C10L 1/02

(52) U.S. Cl. CPC F02D 41/0025; F02D 19/0655; F02D 19/12; F02M 37/0064; C10L 1/231; C10L 1/02; C10L 2290/58; C10L 2200/0259; C10L 2270/02; C10L 2290/141; C10L 2290/143; C10L 2290/24; F02D 2200/021

(57) ABSTRACT

A method of increasing efficiency of a combustion system, which runs with alcohol fuels, by injecting a controlled quantity of a fuel additive. The method includes using one of a single injector tip for pre-mixed alcohol fuel and fuel additive or individual injector tips for the alcohol fuel and the fuel additive. The fuel additive includes a mixture of organic compounds of which at least one organic compound includes at least one nitrate molecular group. The method further includes injecting the pre-mixed alcohol fuel and fuel additive or the alcohol fuel and the fuel additive individually into one or more combustion chambers of the engine block. The method also includes controlling a quantity of the fuel additive by a control arrangement associated with a temperature sensor, and controlling a flow-rate of the alcohol fuel by a power control adapted to controller an output power from the engine block.

### TECHNICAL FIELD

The present disclosure relates to combustion systems, for example to combustion systems including internal combustion engines. Moreover, the present disclosure is also concerned with methods of combusting fuels in aforementioned combustion systems. Furthermore, the present disclosure is also concerned with computer program products comprising a non-transitory computer-readable storage medium having computer-readable instructions stored thereon, the computer-readable instructions being executable by a computerized device comprising processing hardware to execute the aforementioned methods.

### BACKGROUND

Combustion systems such as internal combustion engines are well known. In such combustion systems, combustible fuels are oxidized by air to generate hot gases that are used to generate mechanical power, for example for transportation purposes. However, such combustion in air generates as by-products carbonaceous soot particles and Nitrogen oxides (NOx). Several innovations have been devised in recent years to reduce and/or filter such soot particles and Nitrogen oxides (NOx) in exhaust gases from combustion systems.

Contemporary combustion fuels are derived, namely manufactured, from geological fossil reserves. Such fossil reserves are of finite capacity and are being gradually exhausted, as the present World consumption of oil is in an order of 100 million barrels of oil per day. More recently, there is a growing interest in biofuels derived from contemporary biota. The use of biofuel as a motor fuel has been studied in detail already since the 20^{th} Century. In a recent period, alternative fuels, in contradistinction to conventional fossil-reserve-derived fuels, is used as a motor fuel, or an addition to basic fuel, in many countries, such as Brazil, Germany, Sweden and USA [1]. Technologies have been developed for producing motor fuels including plain ethanol, as well as its blends with regular gasoline and diesel fuel to be used in internal combustion engines. Significant innovations relating to alternative fuels are described in patent documents WO2009/106647, U.S. Pat. No. 5,628,805 and DE10339355.

In a European patent document EP0116197B1 (proprietor: AECI Ltd.; inventor Stiff), there is described a fuel additive comprising a mixture of a first component A, and second component B, wherein the first component A is at least one alcohol with a molecular weight of less than 160, and wherein the second component B is at least one organic compound of the formula

NO₂—O—(CH₂CH₂—O—)ₓ—NO₂

wherein x=an integer greater than 3, and wherein the average molecular weight of the at least one compound of formula

NO₂—O—(CH₂CH₂—O—)ₓ—NO₂

is in a range of 260 and about 390, with a proviso that no other compounds of formula

NO₂—O—(CH₂CH₂—O—)ₓ—NO₂

are present. Optionally, the fuel additive is added to a fuel such as ethanol and/or methanol to provide a mixture which can be combusted in combustion engines, for example in cylinder-based internal combustion engines. The additive is capable of improving fuel ignition in cylinder-based internal combustion engines, for example at lower temperatures when such engines are started and their respective engine blocks are cold.

Over recent years, many different fuel additives have been developed. An example is a contemporary fuel additive known as “Avocet”, “Avocet” is a trademark.

In mid-1980's, a South African chemicals group, AECI, introduced a “green innovation” in the area of fuels, namely “Encetal”; “Encetal” is a trademark. Encetal was developed for purposes of seeking to increase a local consumption of methanol produced from local coal feedstock, which could be used as an alternative to imported oil for fuels. “Encetal”, the name of the fuel mixture of Methanol and Avocet, burns cleanly, producing low amounts of pollutant gases (Nitrous Oxide and Carbon Monoxide) and particulates in a vehicle's exhaust. Moreover, Avocet is an ignition improver to allow methanol fuel to be used in diesel engines, requiring a minimum of engine modifications to accommodate its use.

Avocet has been employed in several tests using alcohols as biofuels, to substitute for fossil-reserve-derived diesel fuel in private and public transportation vehicles. In the mid-1990s, ethanol containing 4% Avocet as an ignition enhancer was tested in a small controlled group of public transport vehicles [1]. Theory predicts a significantly higher volume consumption of ethanol, in comparison to diesel fuel, but the exact higher volume has to be calculated for each case, since it depends on the specific characteristics of the vehicle (e.g. engine operating temperature) and the detailed composition of the fuel itself. It was found from the tests that the use of ethanol-Avocet fuel consumed 84% more per volume, which both negatively compensated for an initial economic argument as well as presented a new significant logistic challenge of transporting 84% more fuel by volume.

Moreover, the use of alcohols in existing diesel engines also requires some modifications to be made to engine components to prevent chemical degradation due to exposure to alcohols. Further improvements in engine operation, temperature and catalysts are needed in preparation for the use of ethanol and other alcohols as a replacement for diesel fuel. As far as economic arguments are concerned, a reduction in the use of Avocet, which represents a significant proportion of the costs, potentially makes combustion systems cheaper, potentially sufficiently to compensate for the comparative ratio Alcohol/diesel; as above, ethanol is taken as the reference, ethanol/diesel=1.84.

An initial economic argument for using the Avocet-enhanced methanol fuel as a diesel replacement was based on an average 25% cost savings when comparing the same volume of methanol to diesel fuel. Meanwhile, environmental arguments pointed out less particulate emissions and less smokiness of such Avocet-enhanced methanol fuel. However, in early 1990's, the use of Avocet as an ignition improver or as a fuel enhancer was deemed impractical and/or expensive for regular automobiles and other road vehicles by the parent company ICI-UK (Imperial Chemical Industries UK was the holding company of the group that owned AECI). This conclusion was reached, in part, due to the lack of commercial drive for environmentally friendly fuels when the additive was introduced in early 1980s. Since then, there has been little activity in this area of work.

Although the composition of Avocet is proprietary, and may have varied over time, the composition of the original Avocet additive includes following components as provided in Table 1:

TABLE 1
Original Avocet composition

| Component part | Percentage composition |
|---|---|
| PEG (PolyEthyleneGlycol) dinitrate | 80% |
| Methanol | 18% |
| Lubricity additive | 1.5% |
| Antioxidant | 0.1% |

However, as aforementioned, Avocet is prohibitively expensive for use in many contemporary combustion systems, which has unfortunately limited its general use.

### SUMMARY

The present disclosure seeks to provide an improved combustion system, for example a combustion system which is capable of running efficiently on fuels such as methanol and ethanol.

Moreover, the present disclosure seeks to provide an improved method of operating a combustion system, for example a combustion system which is capable of running efficiently on fuels such as methanol and ethanol.

According to a first aspect, there is provided a method of increasing efficiency of a combustion system, which runs with alcohol fuels, by injecting a controlled quantity of a fuel additive into an engine block of the combustion system, wherein the method includes:

(a) using one of a single injector tip for a pre-mixed alcohol fuel and fuel additive or individual injector tips for the alcohol fuel and the fuel additive, wherein the single injector tip is configured to inject the pre-mixed alcohol fuel and fuel additive into the engine block, wherein the individual injector tip for fuel additive is positioned prior to a spatial location whereat the individual injector tip for alcohol fuel injects the alcohol fuel into the engine block, and wherein the fuel additive includes a mixture of organic compounds of which at least one organic compound includes at least one nitrate molecular group;

(b) injecting the pre-mixed alcohol fuel and fuel additive or the alcohol fuel and the fuel additive individually into one or more combustion chambers of the engine block; and

(c) using a control arrangement for controlling a quantity of the fuel additive which is injected, wherein the control arrangement includes an on-board computer linked to a temperature sensor placed on the engine block, and is operable to control a flow-rate of the alcohol fuel which is injected, wherein the flow-rate of the alcohol fuel is controlled by a power control for controlling output power from the engine block.

Optionally, the pre-mixed alcohol fuel and additive is mixed in a pre-mixing chamber.

More optionally, the individual injector tips for the alcohol fuel and the fuel additive are arranged prior to the pre-mixing chamber.

Optionally, the alcohol fuel includes at least one of methanol, ethanol and a combination thereof.

Optionally, the engine block is a multi-fuel engine block which is also capable of operating using diesel fuel.

Optionally, the power control is a vehicle accelerator of a vehicle, and the engine block provides mechanical output power to propel the vehicle.

Optionally, the fuel additive is Avocet.

Optionally, the fuel additive is a PEG (poly-5 ethylene glycol) trinitrate derivative.

Optionally, the fuel additive is blended with the fuel in a volumetric concentration in a range of 0.5% to 10%, more optionally in a range of 1% to 7%.

Optionally, the fuel additive is a mixture of Avocet and PEG (poly-5 ethylene glycol) trinitrate derivative.

Optionally, the molecule with the at least one nitrate molecule group includes a molecule of the formula:

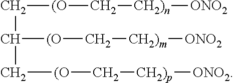

According to another aspect, there is provided a combustion system which is run in operation with alcohol fuels by injecting a controlled quantity of fuel additive into an engine block of the combustion system, wherein the combustion system is operable:

(a) to use one of a single injector tip for pre-mixed alcohol fuel and fuel additive or individual injector tips for the alcohol fuel and the fuel additive, wherein the single injector tip is configured to inject the pre-mixed alcohol fuel and fuel additive into the engine block, wherein the individual injector tip for fuel additive is positioned prior to a spatial location whereat the individual injector tip for alcohol fuel injects the alcohol fuel into the engine block, and wherein the fuel additive includes a mixture of organic compounds of which at least one organic compound includes at least one nitrate molecular group;

(b) to inject the pre-mixed alcohol fuel and fuel additive or the alcohol fuel and the fuel additive individually into one or more combustion chambers of the engine block; and

(c) to use a control arrangement for controlling a quantity of the fuel additive which is injected, wherein the control arrangement includes an on-board computer linked to a temperature sensor placed on the engine block, and is operable to control a flow-rate of the alcohol fuel which is injected, wherein the flow-rate of the alcohol fuel is controlled by a power control for controlling output power from the engine block.

According to yet another aspect, provided is a method for increasing efficiency of alcohol fuels, wherein the method includes:

(i) injecting a fuel additive, that includes a mixture of organic compounds of which at least one organic compound includes at least one nitrate molecular group, into a pre-mixing chamber, wherein a quantity of fuel additive injected is controlled by an on-board computer linked to a temperature sensor placed on an engine block; and

(ii) using a fuel flow-rate sensor to control a flow-rate of an alcohol fuel to the engine block by a vehicle accelerator, which in turn is controlled by a vehicle driver.

According to still another aspect, provided is a method a monitoring system for monitoring an engine block temperature and alcohol fuel flow-rates of a combustion system, wherein the monitoring system is operable to calculate and dispense a controlled amount of fuel additive as a function of the engine block temperature and/or alcohol fuel flow-rates.

According to yet another aspect, provided is a computer program product comprising a non-transitory computer-readable storage medium having computer-readable instructions stored thereon, the computer-readable instructions being executable by a computerized device comprising processing hardware to execute the method pursuant to the above aspects.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

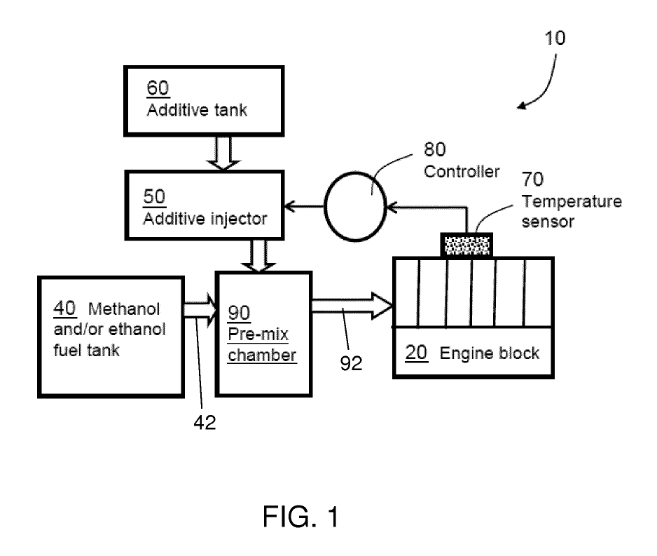

FIG. 1 is a block diagram of a combustion system, according to an embodiment of the present disclosure;

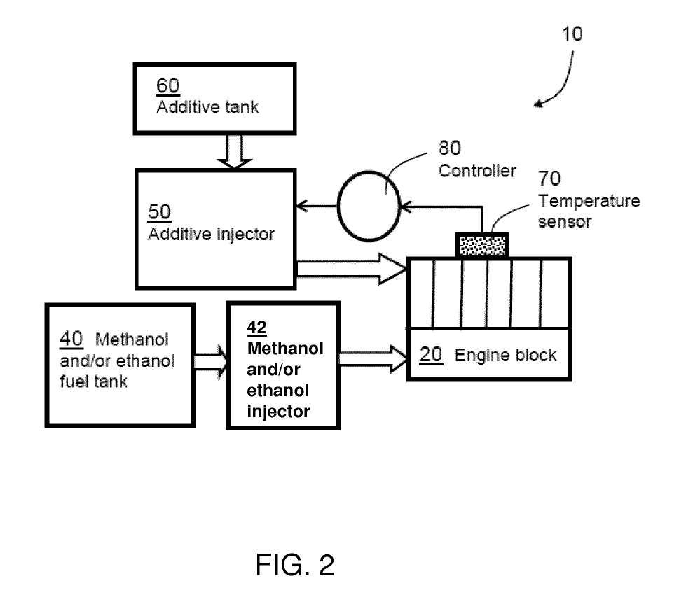

FIG. 2 is a block diagram of a combustion system, according to another embodiment of the present disclosure; and

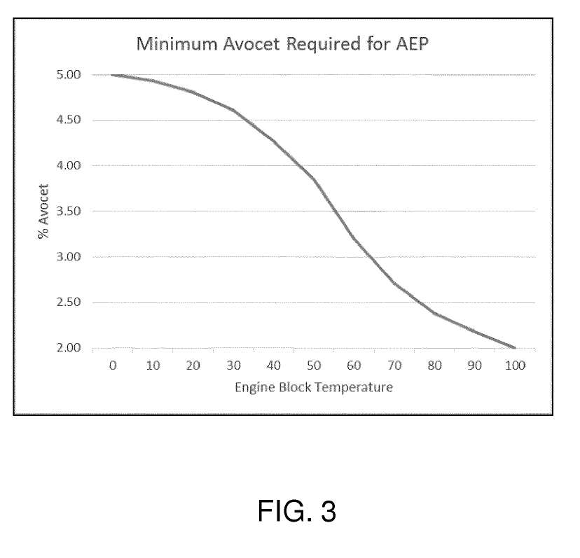

FIG. 3 is a graph depicting a percentage of a fuel additive which is required to achieve an Acceptable Engine Performance (AEP), according to an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE DISCLOSURE

In overview, the present disclosure is concerned with a combustion system, for example a cylinder combustion engine or a combustion turbine engine, wherein a mixture of air, a fuel and an additive are burned, wherein a quantity of the additive employed is controlled, as a function of one or more operating parameters of the combustion system, for example an apparatus temperature of the combustion system, for example an engine block temperature.

The environmental benefits of using an alcohol, as a replacement for diesel fuel, has been well established in prior-art, since a combustion system employing such alcohol as a fuel produces lower amounts of pollutant gases and particulates in a vehicle's exhaust in comparison to fuels such as petrol and diesel. Moreover, in recent years, governments and society in general have been increasingly applying pressure on companies to adopt environmentally friendly alternatives. Therefore, as the intrinsic environmental benefits of using alcohols as a running fuel of contemporary combustion-engine vehicles are well-accepted and understood, it is clear from the foregoing that improving the economic efficiency of the use of alcohols as alternative fuels is a key problem to be addressed.

Specifically, the cost of additives such as Avocet is one of the major intrinsic costs of employing alcohol as a fuel, for example based on methanol or ethanol, although such additives are often added at a concentration of around 5%. Contemporary diesel engines utilize compression ratios that require at least 4% additive, for example Avocet, or more to be added as an ignition improver. Without such additives, such contemporary engines cannot start with alcohol alone. For instance, this is the reason why in contemporary vehicles run with ethanol, a significant amount of petrol (gasoline) is added to the mixture, typically ˜20%.

However, beneficially, this dependence on the amount of additive employed as an ignition improver is directly associated with an operating temperature of a given combustion engine. A higher engine running temperature decreases a requirement for Avocet addition. Thus, after the given engine starts from a cold state, the temperature of the engine gradually increases up to a working operating temperature for the engine, for example a maximum temperature for the engine. At this working operating temperature, for example maximum operating temperature, a typical diesel engines requires about 1% additive, for example Avocet, added to methanol or ethanol to run efficiently. As shown by a cost calculation below, if the amount of Avocet were to be gradually decreased as the temperature of the given engine were increased, this would represent significant economic gains, namely an improvement in efficiency.

To address this aforementioned problem of inefficient use of additives, embodiments of the present disclosure relate to a novel manner of using alcohols in a mixture with additives, for example Avocet, as a diesel replacement. This is achieved, for example, by having individual injection of methanol and at least one additive, for example Avocet. Both the efficiency and economics of such combustion systems employing such separate injection can be improved by dynamically controlling the amount of additive which is injected, namely needed. In one example embodiment, an additive and methanol are injected directly into the engine, for example into one or more cylinders of a piston/cylinder combustion engine; such operation is beneficially referred to as being “in situ addition”. In another example, additive and methanol are pre-mixed in a pre-mixing chamber for being injected into the engine.

In a first example embodiment of the present disclosure, an additive, for example Avocet, is injected in-line, taking advantage of an alcohol flow-line already linked to the given engine; such an arrangement is shown in FIG. 1, wherein a pre-mixing chamber is replaced by an in-line valve in the fuel-line. In FIG. 1, a combustion system is indicated generally by 10. The system 10 includes an engine block 20 including one or more piston/cylinder combustion chambers; alternatively, the engine block 20 is implemented as a turbine with an air compressor coupled to an exhaust turbine driven by combustion gases. Moreover, the system 10 includes a pre-mixing chamber 90 which receives injected fuel, for example methanol, from a fuel tank 40 and also injected additive, for example Avocet or similar, via a fuel additive injector 50 from an additive tank 60. The system 10 also includes a flow-rate sensor which is operatively coupled to the alcohol fuel injector 42 for controlling a flow-rate of the alcohol fuel dispensed by an alcohol fuel injector 42 into the pre-mixing chamber 90. Moreover, as shown in FIG. 1, the fuel additive injector 50 and the alcohol fuel injector 42 are arranged prior to the pre-mixing chamber 90.

Further, the system 10 of FIG. 1 includes a single injector tip 92 for the pre-mixed alcohol fuel and fuel additive. The single injector tip 92 is configured to inject the pre-mixed alcohol fuel (methanol and/or ethanol) and fuel additive (for example Avocet) into the engine block 20. Furthermore, the system 10 includes a temperature sensor 70 which is placed (namely mounted) on the engine block 20 to sense a temperature of the engine block 20 and to generate a signal representative of the measured, namely sensed, temperature. Additionally, the system 10 includes a controller 80, for example implemented as a computing device, for receiving the signal from the temperature sensor 70 and for providing an output, which is computed from the signal, wherein the output is employed to control a rate of injection of the additive from the additive tank 60 into the pre-mixing chamber 90. A mixture of fuel and additive is provided in operation from the pre-mixing chamber 90 into the engine block 20 for combustion therein to generate mechanical output power from the engine block 20. The controller 80 is operable to control injection of the additive as a function of at least one of following parameters:
(i) a compression ratio employed within one or more combustion chambers of the engine block 20;
(ii) a temperature range for the engine block 20 in operation under various usage regimes, for example mechanical load driven by the engine block 20, engine block 20 rotation rate, and so forth;
(iii) additive concentration needed for smooth ignition of the engine block 20; and
(iv) engine block 20 ignition timing for reducing, for example minimizing, use of the additive in operation.

In another example embodiment of the present disclosure, pre-mixing of the fuel, for example methanol or another alcohol, and the additive, for example Avocet, is not performed prior to injecting the fuel (i.e. the mixture alcohol fuel and the fuel additive) into the engine block 20. Specifically, the system 10 includes individual injectors for the alcohol fuel and the fuel additive. For example as illustrated in FIG. 2, the system 10 includes the fuel additive injector 50 and the alcohol fuel injector 42. The fuel additive injector 50 is positioned prior to a spatial location, whereat the alcohol fuel injector 42 injects the alcohol fuel into the engine block 20. The system 10 also includes the flow-rate sensor for controlling a flow-rate of the alcohol fuel dispensed by the alcohol fuel injector 42 directly into the engine block 20. Further, the quantity of the fuel additive to be injected directly into the engine block 20 is controlled by the controller 80, receiving the signal from the temperature sensor 70.

In all embodiments described above, the direct addition of the additive, for example Avocet, is achieved by adding a compact, separate reservoir and injector for the additive, for example Avocet. In the first embodiment, the additive, for example Avocet, is injected into a pre-mixing chamber as shown in the FIG. 1. In another embodiment described above, the injector nozzle (or tip) is beneficially placed in-line (i.e. single injector 92) where the fuel is injected into the given engine. This separate injector is beneficially controlled by one or more sensors linked to an on-board computer, from where a computer program product executed upon the on-board computer causes the engine temperature to be sensed and the sensed temperature employed as a parameter for controlling the amount of alcohol pumped into the engine, namely for controlling the alcohol flow-rate. In a normal conventional vehicle, the amount of alcohol required is controlled by an accelerator pedal of the conventional vehicle, which in turn, is controlled by a driver of the conventional vehicle. A flow-rate sensor is employed to measure the alcohol flow-rate. To ensure that an optimum ratio between the additive, for example Avocet, and fuel (methanol or another alcohol) is utilized in the engine, a precisely controlled quantity of additive, for example Avocet, is calculated by the on-board computer and dispensed instantaneously, based for example upon the engine temperature and alcohol flow-rate according to a mechanism, namely method, as will be elucidated in greater detail below.

In overview, a diesel engine fuelled with methanol requires up to 5% additive, for example Avocet, to allow cold starting, but when the engine has reached a steady running temperature, the need for the additive, for example Avocet, is reduced to approximately 1%. Therefore, a simple engine temperature sensor coupled with feedback to an electronically controlled additive injector, for example an Avocet injector, is capable of reducing drastically the cost of additive usage, for example Avocet usage, namely a cost that is a major consideration in determining the economic viability of ignition-improved methanol, for example. Optionally, in practice, the fuel methanol is beneficially treated with a lubricity additive, since the need for lubricity is independent of the need for ignition enhancement, and of course, a small separate additive tank, for example Avocet tank, is beneficially installed together with a fuel delivery system.

When embodiments of the present disclosure are implemented in respect of a vehicle equipped with a combusting engine, for example for providing motive force to propel the vehicle when in operation, there is beneficially provided a separate storage tank for additive, for example Avocet or similar combustion-enhancing composition. Optionally, the additive (e.g. Avocet) is introduced via a separate injector into a pre-chamber that mixes the additive and the fuel to generate a mixture for combustion within the engine, or, alternatively, the additive is injected directly into the engine.

The quantity of additive injected, can be controlled via the provision of a sensor capable of measuring a degree to which the engine has reached steady operating conditions. The quantity of additive injected will vary according to the information provided by such sensor. For example, such sensor may measure temperature at an appropriate location in or on the engine block or the exhaust system, or an appropriate sensor may measure any other engine-related or exhaust-gas-related parameter capable of indicating the operating status of the engine.

Optionally, the quantity of additive (e.g. Avocet) is controlled by a separate electronic injection system, which uses information from a temperature sensor (operable to sense engine temperature) and from the fuel injector (amount of fuel) to calculate a precise amount of additive to be injected. Optionally, the separate electronic injection system can use information from sensors that measure the time travelled and/or the distance travelled, both of which can be directly linked to the engine temperature where the rate of engine warm-up, respectively with time and/or distance, is either known, modelled or measured.

More optionally, a flow-rate sensor is placed in the fuel line to improve accuracy of measurement of fuel utilization by the engine, and hence improves an accuracy of additive injection.

Alternatively, optionally, it is potentially advantageous to inject the additive (e.g. Avocet) directly into the cylinder, rather than premixing it with a fuel, for example methanol. This gives many more possibilities for fine tuning the engine and optimizing its operating performance. Optionally, at least one of nine main variations is beneficially employed. Firstly, there are three injection timing possibilities that are susceptible to being utilized:

(i) injection of the additive occurs before a maximum compression in a piston/cylinder combustion chamber occurs; if the maximum compression occurs at a shaft angle of 0° in a 360° shaft rotation cycle, the injection optionally occurs when the shaft angle is in a range of −10° to −0.1° before the maximum compression, and more optionally the injection occurs when the shaft angle is in a range of 3° to −0.1° before the maximum compression;

(ii) injection of the additive occurs at the maximum compression in the combustion chamber; if the maximum compression occurs at a shaft angle of 0° in a 360° shaft rotation cycle, the injection optionally occurs when the shaft angle is in a range of −3° to +3° relative to the maximum compression, and more optionally the injection occurs when the shaft angle is in a range of −1° to +1° relative to the maximum compression; and

(iii) injection of the additive occurs after the maximum compression in the combustion chamber; if maximum compression occurs at a shaft angle of 0° in a 360° shaft rotation cycle, the injection optionally occurs when the shaft angle is in a range of +10° to +0.1° after the maximum compression, and more optionally the injection occurs when the shaft angle is in a range of +3° to +0.1° after the maximum compression.

Associated with each of these three aforementioned options (i) to (iii) is an option of injecting the additive (e.g. Avocet) as follows:

(a) slightly before fuel injection (e.g. methanol and/or ethanol injection);

(b) simultaneously with fuel injection (e.g. methanol and/or ethanol injection); and

(c) slightly after fuel injection (e.g. methanol and/or ethanol injection).

Optionally, the amount of additive injected, and the timing in a combustion cycle when the additive is injected, is beneficially varied as a function of at least one of following parameters:

(iv) a maximum power delivered by the engine;

(v) a minimum NOₓ generated by the engine;

(vi) a minimum additive usage (e.g. Avocet usage);

(vii) a minimum fuel usage per unit of power delivered by the engine; and

(viii) a smooth starting and operation of the engine.

Optionally, control of the engine dynamically switches between a selection of (iv) to (viii), for example in a continuous or step-wise manner. Beneficially, an engine mapping test design is employed in order to determine the overall optimum setting required to accomplish, namely to achieve, best operational economics for the engine, in view of injection of the additive.

Embodiments of the present disclosure provide economic benefits as will now be elucidated in greater detail. Benefits stem from controlling the judicial use of additive (e.g. Avocet or similar), which also brings added environmental benefits, since the additive (e.g. Avocet or similar) is responsible for a small amount of particulate Carbon expelled within exhaust gases from the engine.

Embodiments of the present disclosure are beneficially implemented in new engine designs. Alternatively, or additionally, embodiments of the present invention are retrofitted to known engine types.

Quantitative estimates of the cost benefits to be derived from the additive (e.g. Avocet) injection, compared with the alternative of using a fixed concentration pre-mixed with the methanol fuel, can be computed. To do such a computation, an additive (e.g. Avocet) cost first needs to be estimated. A large volume production facility for the additive can be estimated to cost between GBP 2500 and 3000/MT as a guide; “MT” is an abbreviation for “metric tonne”. Using the lowest cost figure within the range, each litre of methanol fuel at 5% addition of additive would contain 10 pence worth of additive (e.g. Avocet).

Assuming methanol fuel is available at a cost of 20 p/litre, two scenarios as follows can be computed:

Scenario 1: A diesel truck running 200 miles consuming 1 litre methanol fuel with 5% additive (e.g. Avocet) injection per mile:

| | |
|---|---|
| Methanol cost | GBP 40.00 |
| Avocet cost | GBP 20.00 |
| Total fuel cost | GBP 60.00 |

Scenario 2: The same diesel truck with additive (e.g. Avocet) injection:

| | |
|---|---|
| First 5 miles with 5% Avocet injection: | GBP 0.50 |
| Second 5 miles with 2% Avocet injection | GBP 0.20 |
| Final 190 miles with 1% Avocet injection: | GBP 3.80 |
| 200 litres methanol | GBP 40.00 |
| Total fuel cost | GBP 44.50 |

Clearly, the use of additive injection significantly reduces an overall fuel cost, in this case by 25%. More importantly, the cost of the additive (e.g. Avocet) reduces from GBP 20.00 to GBP 4.50, a decrease of 77.5%. It will be appreciated that this number of 77.5% is a function of journey length, diminishing with shorter journeys, and increasing with longer journeys.

Referring now to FIG. 3, there is depicted a graph showing a percentage of a fuel additive, i.e. Avocet, required to achieve the AEP. Specifically, FIG. 3 depicts the consumption (or need) of Avocet, by the percentage thereof in the fuel, with the rise in the temperature of the engine block to achieve the AEP. As shown, about 5% of Avocet is required when the temperature of the engine block is about 0 degrees Centigrade (cold start); however, at 100 degrees Centigrade, about 2% of Avocet is required. The result shown in FIG. 3 is associated with a single cylinder Honda diesel engine with a compression ratio of 19.5, and without any optimisation of timing. Therefore, lower AEP percentages may be obtained with modern multi-cylinder engines having variable injection timing, higher compression ratios, and the like.

As shown in FIG. 3, even by minimizing the amount of fuel additive, i.e. Avocet, with the rising temperature of the engine block, it is feasible to achieve AEP. For example, the amount of Avocet required for AEP can vary from 5% initially to 2% or less, however the precise numbers depend upon the specific engine and its performance configuration. Congruent with the results shown in FIG. 3, if Avocet is priced at $5000 (USD) per tonne, for each percentage point reduction in Avocet usage, the cost saving per US gallon of Avocet Fuel is about 14 cents. Additionally, the use of Avocet based fuel offers very significant reductions in NOₓ (oxides of nitrogen) and carbon-monoxide emission. Therefore, by optimizing engine performance parameters, consumer and regulatory goals for vehicle engine emissions can be achieved.

In an example, the fuel additive includes a mixture of organic compounds of which at least one organic compound includes at least one nitrate molecular group.

Additionally, the fuel additive can be a PEG (poly-5 ethylene glycol) trinitrate derivative. Further, the fuel additive, i.e. PEG (poly-5 ethylene glycol) trinitrate derivative, may be blended with the fuel in a volumetric concentration in a range of 0.5% to 10%, more optionally in a range of 1% to 7%. The additive is operable to function as a cetane enhancer when mixed with a fuel and combusted within a combustion engine.

Moreover, the fuel additive can be a mixture of Avocet and PEG (poly-5 ethylene glycol) trinitrate derivative.

In an example, the molecule with the at least one nitrate molecule group includes a molecule of the formula:

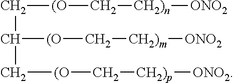

wherein

n, m, p are integers which represent the number of basic monomers in an ethoxylate chain in the additive. Further, the additive is chosen from compounds with n, m and p varying in a range of 1 to 5.

Embodiments of the present invention can be implemented with a large spectrum of combustion systems, for example as employed in one of more of following apparatus: automobiles, trucks, buses, vans, motorcycles, stationary generators, turbine engines, aircraft, ships, boats, hovercraft, submarines, helicopters, but not limited thereto.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

### REFERENCE LITERATURE

[1] Gaouyer, J. P.: “What has happened in Europe in the Biofuels Domain over the last two years?” Proceedings 2nd European Motor Biofuels Forum, Graz, p. 37-41, 1996.

1-25. (canceled)

26. A method of increasing an operating efficiency of a combustion system, which is configured to run with alcohol fuels, by injecting a controlled quantity of a fuel additive into an engine block of the combustion system, wherein the method includes:
(a) using one of a single injector tip for pre-mixed alcohol fuel and fuel additive or individual injector tips for the alcohol fuel and the fuel additive, wherein the single injector tip is configured to inject the pre-mixed alcohol fuel and fuel additive into the engine block, wherein the individual injector tip for fuel additive is positioned prior to a spatial location whereat the individual injector tip for alcohol fuel injects the alcohol fuel into the engine block, and wherein the fuel additive includes a mixture of organic compounds of which at least one organic compound includes at least one nitrate molecular group;
(b) injecting the pre-mixed alcohol fuel and fuel additive or the alcohol fuel and the fuel additive individually into one or more combustion chambers of the engine block; and
(c) using a control arrangement for controlling a quantity of the fuel additive which is injected, wherein the control arrangement includes an on-board computer linked to a temperature sensor placed on the engine block, and controlling a flow-rate of the alcohol fuel which is injected, wherein the flow-rate of the alcohol fuel is controlled by a power control for controlling output power from the engine block.

27. A method as claimed in claim 26, wherein the pre-mixed alcohol fuel and fuel additive are mixed in a pre-mixing chamber.

28. A method as claimed in claim 26, wherein the individual injector tips for the alcohol fuel and the fuel additive are arranged prior to the pre-mixing chamber.

29. A method as claimed in claim 26, wherein the alcohol fuel includes at least one of: methanol, ethanol, and a combination thereof.

30. A method as claimed in claim 26, wherein the engine block is a multi-fuel engine block which is also capable of operating using diesel fuel.

31. A method as claimed in claim 26, wherein the power control is a vehicle accelerator of a vehicle, and the engine block provides mechanical output power to propel the vehicle.

32. A method as claimed in claim 26, wherein the fuel additive includes at least one of: Avocet, PEG (poly-5 ethylene glycol) trinitrate derivative and a combination thereof.

33. A method as claimed in claim 32, wherein the fuel additive is blended with the fuel in a volumetric concentration in a range of 0.5% to 10%, more optionally in a range of 1% to 7%.

34. A method as claimed in claim 26, wherein the at least one nitrate molecule group includes a molecule of the formula: 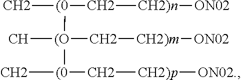
wherein m, n and p are integers

35. A combustion system configured to run with alcohol fuels by injecting a controlled quantity of a fuel additive into an engine block of the combustion system, wherein the combustion system is configured: to use one of a single injector tip for pre-mixed alcohol fuel and fuel additive or individual injector tips for the alcohol fuel and the fuel additive, wherein the single injector tip is configured to inject the pre-mixed alcohol fuel and fuel additive into the engine block, wherein the individual injector tip for fuel additive is positioned prior to a spatial location whereat the individual injector tip for alcohol fuel injects the alcohol fuel into the engine block, and wherein the fuel additive includes a mixture of organic compounds of which at least one organic compound includes at least one nitrate molecular group; to inject the pre-mixed alcohol fuel and fuel additive or the alcohol fuel and the fuel additive individually into one or more combustion chambers of the engine block; and to use a control arrangement for controlling a quantity of the fuel additive which is injected, wherein the control arrangement includes an on-board computer linked to a temperature sensor placed on the engine block, and controlling a flow-rate of the alcohol fuel which is injected, wherein the flow-rate of the alcohol fuel is controlled by a power control for controlling output power from the engine block.

36. A combustion system as claimed in claim 35, wherein the pre-mixed alcohol fuel and fuel additive are mixed in a pre-mixing chamber.

37. A combustion system as claimed in claim 35, wherein the individual injector tips for the alcohol fuel and the fuel additive are arranged prior to the pre-mixing chamber, wherein the alcohol fuel includes at least one of methanol, ethanol, and a combination thereof.

38. A combustion system as claimed in claim 35, wherein the engine block is a multi-fuel engine block which is also capable of operating using diesel fuel.

39. A combustion system as claimed in claim 35, wherein the power control is a vehicle accelerator of a vehicle, and the engine block is configured to provide mechanical output power to propel the vehicle.

40. A combustion system as claimed in claim 35, wherein the fuel additive includes at least one of: Avocet PEG (poly-5 ethylene glycol) trinitrate derivative and a combination thereof.

41. A combustion system as claimed in claim 40, wherein the fuel additive is blended with the fuel in a volumetric concentration in a range of 0.5% to 10%, more optionally in a range of 1% to 7%.

42. A combustion system as claimed in claim 35, wherein the at least one nitrate molecule group includes a molecule of the formula:

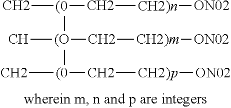

43. A method for increasing efficiency of alcohol fuels, wherein the method includes: injecting a fuel additive, that includes a mixture of organic compounds of which at least one organic compound includes at least one nitrate molecular group, into a pre-mixing chamber, wherein a quantity of fuel additive injected is controlled by an on-board computer linked to a temperature sensor placed on an engine block; and using a fuel flow-rate sensor to control a flow-rate of an alcohol fuel to the engine block in response to a vehicle accelerator, which in turn is controlled by a vehicle driver.

44. A monitoring system for monitoring an engine block temperature and alcohol fuel flow-rates of a combustion system as claimed in claim 37, wherein the monitoring system is configured to calculate and dispense a controlled amount of fuel additive as a function of the engine block temperature and/or alcohol fuel flow-rates.

45. A computer program product comprising a non-transitory computer-readable storage medium having computer-readable instructions stored thereon, the computer readable instructions being executable by a computerized device comprising processing hardware to execute the method as claimed claim 26.
